(19) United States
(12) Patent Application Publication
(10) Pub. No.: US 2008/0308631 A1
(43) Pub. Date: Dec. 18, 2008

(54) Hand-Held Device for Parking Meter Enforcement

(76) Inventors: Frederick L. Mitschele, Vancouver (CA); Jason M.J. Mitschele, Toronto (CA); Michael W. Minor, Middlesex (GB)

Correspondence Address: OYEN, WIGGS, GREEN & MUTALA LLP;480 - THE STATION, 601 WEST CORDOVA STREET, VANCOUVER, BC, V6B 1G1, CA

(21) Appl. No.: 11/571,243

(22) PCT Filed: Jun. 23, 2005
(86) PCT No.: PCT/CA05/00985

§ 371 Date: Jan. 28, 2008

Related U.S. Application Data
(60) Provisional application No. 60/581,715, filed on Jun. 23, 2004.

(51) Int. Cl. G07B 1/00

(52) U.S. Cl. 235/384

(57) ABSTRACT

The present invention provides a hand-held violation ticket issuing device which incorporates a digital camera so that the ticket can be printed with an image of the vehicle license plate and the expired meter and/or expired parking receipt or other evidence of a violation.

### TECHNICAL FIELD

The invention relates to the field of parking meter enforcement and more particularly handheld computer devices for use in parking meter and parking offence enforcement.

### BACKGROUND

Parking meters and other parking payment units, such as pay and display units and pay by stall ticket dispensers, are in widespread use by municipalities to collect revenues. Conventionally, parking officials or “meter maids” patrol city streets, roads and parking lots by vehicle and/or on foot, and when a parking violation is located, issue a parking ticket by hand, noting the vehicle license number on the ticket along with other information. Errors or inaccuracies in the information entered on the ticket are common in this procedure and can lead to invalid tickets or tickets which can be successfully challenged. Also poor hand-writing may make the information difficult to decipher. More recently, some municipalities have introduced hand-held computers and printers for issuing parking violation tickets. Such systems use personal digital assistants with stylus data entry, or hand-held computers, and a thermal printer. In other applications, hand-held computers have used portable printers of the dot matrix or inkjet variety, with wireless, either infrared or Bluetooth™, or wired connection.

### SUMMARY OF INVENTION

The present invention provides a hand-held violation ticket issuing device which incorporates a digital camera so that the ticket can be printed with an image of the vehicle license plate and the expired meter or other evidence of a violation. The image can be stored in electronic digital format with the ticket/violation information and be retrieved at any time. The hand held violation ticket issuing device may also incorporate a built in communication device such as a walkie talkie or mobile/cellular phone. The communication device may be automatically prompted to make a connection during certain events.

### BRIEF DESCRIPTION OF DRAWINGS

In drawings which illustrate a preferred embodiment of the invention:

FIG. 1 is a front view of a hand-held device according to the invention;

FIG. 2 is a front perspective view of a hand-held printer for use with the invention;

FIG. 2 is an end perspective view of a hand-held device according to the invention; and

FIG. 4 is a plan view of a ticket printed according to the invention.

### DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

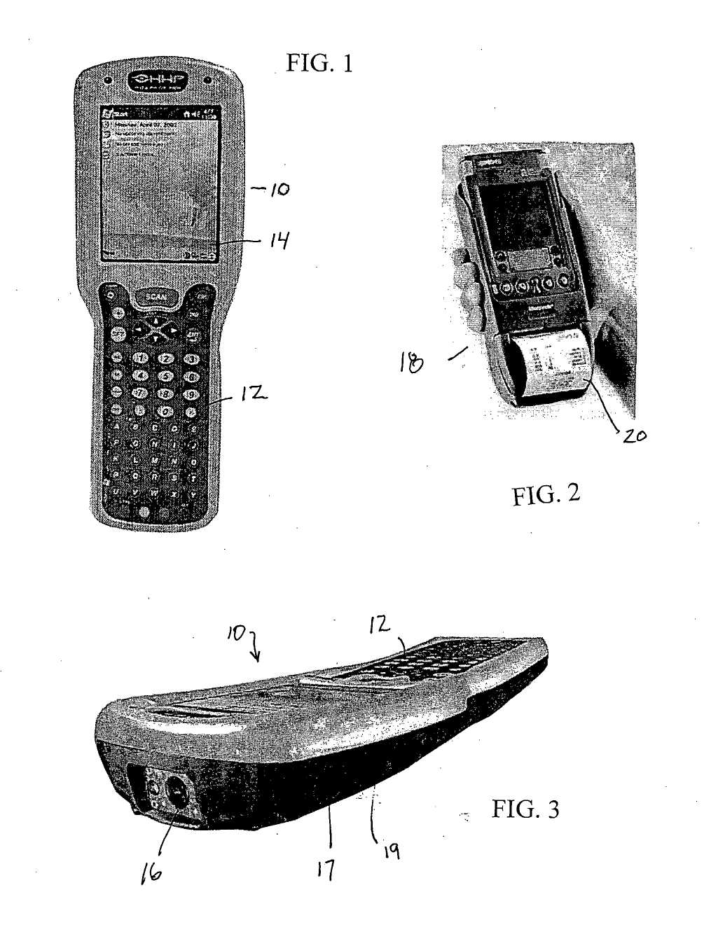

With reference to FIG. 1-3, a hand-held computer 10 has a digital processor, keypad 12, display screen 14 and also incorporates a digital camera 16 capable of taking digital pictures when issuing parking violations. A separate portable thermal printer 18 is used to print the parking ticket 20 and communicates, preferably wirelessly by infrared or Bluetooth™ with the hand-held computer 10 via infrared port 17. Suitable hand-held computers with image capture are manufactured by Hand Held Products, sold under the trademark Dolphin® 7200 2D Hand Held Portable Data Collection Terminal as well as the model 7200IC, 7400 and 9500. Such devices include a high resolution CMOS digital-image-camera 16 with an integrated image-processor, to record TIF or JPEG image files. Such devices may also include an IRDa infrared data port 17 for communicating with printer 18 and built-in wireless WAN, LAN or PAN radio communication for data communication with a central station. For example there may be provided an internal type-II PC-Card slot for 2.4 GHz RF LAN or WWAN radios to wirelessly transmit or receive data. Printer 18 may be any other form of portable printer such as dot matrix or inkjet, and may have a wired connection to hand-held computer 10 rather than wireless.

Preferably data storage is provided in computer 10 so that the image files can be stored in electronic digital format as well as the ticket violation information and be retrieved or transmitted at any time.

Also the hand held computer 10 may incorporate a built in communication device such as a walkie talkie or mobile/cellular phone. Computer 10 may also be provided with a jack 19 for headsets to facilitate audio communication. In this way the parking attendant can communicate and receive data wirelessly and also send and receive wireless voice communication. The communication device could also be automatically prompted to make a connection during certain instances or conditions in the program flow. For example, city police might automatically contact a supervisor before any vehicle is towed for outstanding fines or the communication device could connect directly to the towing company via the communication device for verbal communication. The parking attendant may in this way also be notified wirelessly of the location of a parking violation either from a central server or individual parking meters which are equipped to issue radio or other frequency signals upon occurrence of a violation.

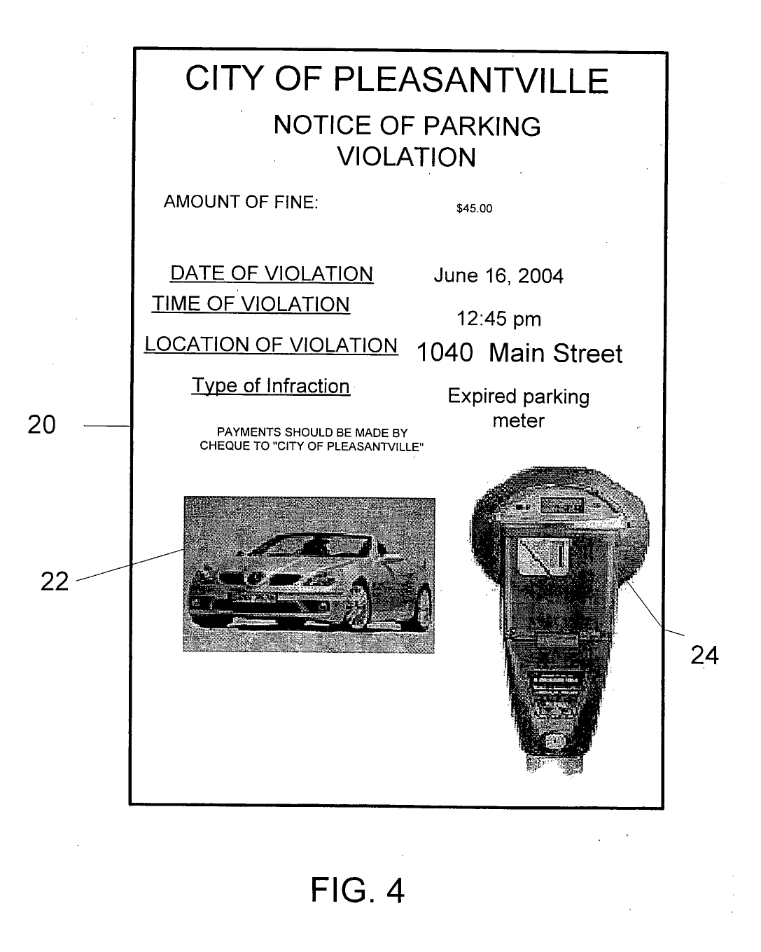

FIG. 4 illustrates the ticket 20 which is printed from the hand-held printer 18 and contains the image 22 of the vehicle license plate and image 24 of the expired meter. These two images are printed on the parking violation and/or infraction notice showing the vehicle in violation and the vehicle infraction in addition to the written data on the notice such as the time, date and location of the violation, type of infraction and amount of the fine. By including the two pictures 22, 24 on the parking violation/notice there is an increase in the number of paid tickets, thereby increasing revenue. Including such images on the tickets also serves to reduce the number of complaints received by the parking authorities issuing the violations which in turn saves time and cost. Fewer parking violators are able to maintain that there was a mistake in recording the license plate or that they did not perform the infraction.

In operation, when a meter maid locates a parking violation, the license plate number, location, type of infraction and other information are entered on keypad 14. A clock included in the device can record the time and date. Alternatively a GPS chip can automatically determine and record the geographic location. Digital images are captured by camera 16 of the license plate in addition to the offending action. For example if a vehicle is parked in front of an expired parking meter, the meter maid would take a picture of the license plate of the vehicle plus take a picture of the expired meter or the vehicle parked in front of the expired parking meter. If the vehicle was parked in front of a fire hydrant the meter maid would take a picture of the license plate and the car parked next to the hydrant. In the case of pay and display machines, the image is taken of the expired parking receipt with a time stamp on the image. The processor then combines the image 22 of the vehicle license plate and image 24 of the violation with the time, date and location of the violation, type of infraction and amount of the fine, and generates a ticket which is sent to printer 18, printed and placed on the vehicle or subsequently sent by mail.

In this way the ticket effectively proves that a particular vehicle was in violation and that no mistake in recording the vehicle was made, as a picture is present to verify the license plate and the offense that had occurred, such as an expired meter, expired parking receipt, no parking zone, or the like. In this way errors or inaccuracies in the information entered on the ticket are reduced, tickets are easier to decipher and so successful challenges to invalidate tickets are reduced and fewer instances of parking personnel in court is required.

The violation information and images are stored electronically in the hand-held 10 and such violation data and images can be downloaded to a main computer or transmitted wirelessly to a central computer, such as through infrared port 17. Images 20 and 22 can then be printed on collection notices sent in the mail to collect the outstanding fines, providing similar benefits to those described above for the parking tickets. In some situations it may be desirable to print the images only on the mailed notices and not on the tickets printed by the meter maids.

The hand-held computer 10 or the central computer may also be provided with image analysis software which will read the license plate number from the digital image 22 of the license plate. Such image analysis software is currently in use, for example, at border crossings to read license plate numbers from a digital image. The number so obtained may then be used to print on the issued printed ticket and/or may be used to cross-check the number entered manually by the meter maid and to locate the vehicle owner for forwarding the ticket or violation notice by mail.

As a further embodiment, where the vehicle is provided with an RFID (Radio Frequency IDentification) chip or tag containing the vehicle license number or identification number, the hand-held computer 10 may include an RFID reader which will scan and read the identification number from the RFID tag. If the identification number is the license plate number then it can use that information instead of, or as a cross-check for the number taken from the digital image 22 or entered manually by the meter maid. Alternatively, the identification number can be sent to the central computer to be used to retrieve the vehicle license number for use in printing on the ticket or notice, cross-checking the information received otherwise and identifying the vehicle owner for forwarding the infraction notice.

Where the parking area is a municipal location with a time-limited parking regulation, the meter maid can use the hand-held device 10 to calculate the length of time the vehicle has been in a location. In this case, the meter maid will take a first image of the vehicle license plate and either manually enter the license number or the image analysis software will read the license number from the digital image. A GPS device may also be included to associate a geographic location with the image and/or license number. The device has a clock which records the time and date at which the image is taken and the information is stored in association with the image and license number. When the meter maid returns some time later, a second image is taken and the license number either entered manually or analysed from the image and the second time and date recorded. The hand-held device then retrieves the earlier data for the same vehicle number, calculates the duration since the last image was taken of the same vehicle and if there is a violation, prints a ticket showing both images with the time and date of each image displayed.

As will be apparent to those skilled in the art in the light of the foregoing disclosure, many alterations and modifications are possible in the practice of this invention without departing from the spirit or scope thereof. While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

What is claimed is:

1. A hand-held violation ticket issuing device comprising:
i) a processor;
ii) a digital camera;
iii) data storage means means coupled with said processor for storing said digital image in association with a vehicle license number;
iv) keypad means coupled with said processor for entering data; and
v) means for communicating data to a printer;
whereby a violation ticket can be digitally generated by said processor and printed by said printer bearing an image of a vehicle license plate and an image providing evidence of a violation.

2. The hand-held violation ticket issuing device of claim 1 further in combination with a printer.

3. The hand-held violation ticket issuing device of claim 1 further comprising:
vi) telecommunications means coupled with said processor for communicating with a second processor.

4. The hand-held violation ticket issuing device of claim 3 wherein said telecommunications means is adapted to wirelessly transmit digital data.

5. The hand-held violation ticket issuing device of claim 3 wherein said telecommunications means is a walkie talkie.

6. The hand-held violation ticket issuing device of claim 3 wherein said telecommunications means is a mobile telephone.

7. The hand-held violation ticket issuing device as defined in claim 3 wherein said telecommunications means comprises a modem.

8. The hand-held violation ticket issuing device as defined in claim 1 further comprising clock means.

9. The hand-held violation ticket issuing device as defined in claim 1 further comprising an RFID (Radio Frequency IDentification) reader.

10. The hand-held violation ticket issuing device as defined in claim 1, further comprising image analysis software stored in said data storage and operable on said processor for determining a license plate number from a digital image taken by said digital camera.

11. The hand-held violation ticket issuing device as defined in claim 1, further comprising a GPS (Global Positioning System) chip.

12. The hand-held violation ticket issuing device as defined in claim 1, further comprising clock means for recording first and second times and dates at which first and second images are taken of a vehicle license plate, whereby said processor stores said first and second times and dates in association with said first and second images and vehicle license numbers and calculates the duration between said first and second images.

13. The hand-held violation ticket issuing device as defined in claim 1
